(19) United States
(12) Patent Application Publication
(10) Pub. No.: US 2015/0090842 A1
(43) Pub. Date: Apr. 2, 2015

(54) Airlock with enlarged viewports

(71) Applicant: Bigelow Aerospace LLC, Las Vegas, NV (US)

(72) Inventor: Robert T. Bigelow, Las Vegas, NV (US)

(73) Assignee: Bigelow Aerospace LLC, Las Vegas, NV (US)

(21) Appl. No.: 14/121,597

(22) Filed: Sep. 22, 2014

Related U.S. Application Data
(60) Provisional application No. 61/960,950, filed on Oct. 1, 2013.

(51) Int. Cl. B64G 1/64; B64G 1/58; B64G 1/40; B64G 1/44; B64G 1/10; B64G 1/60

(52) U.S. Cl. CPC B64G 1/646; B64G 1/10; B64G 1/60; B64G 1/40; B64G 1/44; B64G 1/58
USPC 244/171.9

(57) ABSTRACT

An airlock that provides a substantially 360 view using enlarged viewports is disclosed.

### RELATED APPLICATIONS

This application claims priority under 35 U.S.C. §119 to U.S. Provisional Application No. 61/960,950 filed on Oct. 1, 2013, the contents of which are incorporated herein by reference in its entirety.

### FIELD OF THE INVENTION

This invention generally relates to space vehicles and more particularly to an airlock with an enlarged viewport.

### BACKGROUND OF THE INVENTION

Airlocks are structures that allow transition from one environment to another. In one application, an airlock is situated between a human habitable environment and a more hostile environment such as space. For example, an airlock can be attached to a habitable space station and allow access to space.

One application to this configuration could include an astronaut performing extra-vehicular activities such as repair to the outside of the station. The airlock allows the astronaut to enter and exit the space station with a minimal impact to the habitable environment. The pressure in the station remains relatively constant and the loss of the air within the station to space is minimal.

An airlock may also be used to dock two spacecraft together. In this application the environments on either side of the airlock may be similar or identical. The traditional view of airlocks as a transition device has resulted in airlocks being substantially restricted in application as primarily a doorway between environments.

What is needed is a broader view of airlocks resulting in airlocks having the capability of performing more tasks. For example, due to the location of an airlock, there may be an advantage in having large windows or viewports integrated with the airlock. The viewports could allow occupants to see external areas of the spacecraft as part of a regular maintenance inspection protocol or to assist with docking procedures to another spacecraft. Such viewports could also allow people to enjoy a view of the cosmos.

### SUMMARY OF THE INVENTION

An airlock for use with a spacecraft is disclosed. The airlock has an enclosure defining an airlock space. The enclosure has a substantially cylindrical shape with a first end of the enclosure adapted to attach to a bulkhead of the spacecraft, a second end of the enclosure having a docking port, an external surface of the enclosure, and the enclosure has a plurality of enlarged viewports that provide substantially a 360 degree view from within the airlock. There are also a plurality of thrusters disposed on the external surface of the enclosure and at least one solar array attachment point on the external surface. Further, there is at least one radiator attachment point disposed on the external surface and a control panel within the airlock space.

The control panel provides communications with the spacecraft, status of the airlock, and control for the docking port. The docking port is adapted to dock with another spacecraft and the airlock provides access to the internal volume of the spacecraft.

### BRIEF DESCRIPTION OF THE DRAWINGS

The invention is generally shown by way of reference to the accompanying drawings in which:

FIG. 1 is a top view of an embodiment of an airlock of the present invention;

FIG. 2 is a side view of an embodiment of an airlock of the present invention;

FIG. 3 is another side view of the airlock attached to an inflatable module;

FIG. 4 is a top view of the airlock displaying the solar arrays; and

FIG. 5 is a perspective front view of the airlock attached to an inflatable module.

### DETAILED DESCRIPTION OF THE INVENTION

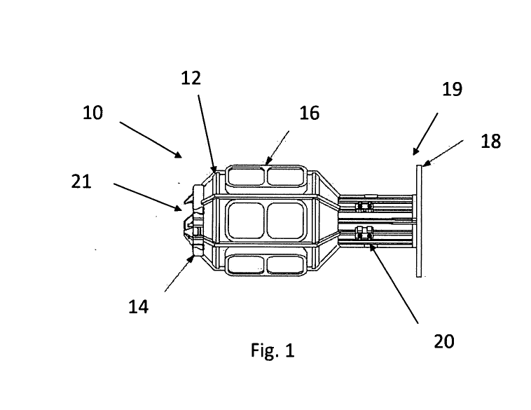

FIG. 1 is a top view of one embodiment of the airlock with enlarged viewports 10. The there is an enclosure 12 that in the present configuration is substantially cylindrical. There is a first end 19 that attaches to a spacecraft. In the preferred embodiment the spacecraft is an inflatable habitable module. However, the spacecraft is not so limited in other embodiments. The first end in the present embodiment attaches to a bulkhead 18 of the spacecraft. The second end 21 has a docking port 14 for docking with other spacecraft. The docking port 14 also allows for an astronaut to move from a spacecraft through the airlock.

The enclosure has a plurality of enlarged viewports 16. The enlarged viewport 16 can be a windows like structure. A single viewport is considered enlarged if it is at least 144 square inches (as an example 12 inches by 12 inches for a square) of viewing area. In other embodiments the geometry of the viewports can vary as for an example to being round or oblong. Still other embodiments can use viewports of different sizes. Yet other embodiments could incorporate covers, either inside or outside of the airlock that would cover the viewports when desired.

The enclosure 12 defines an internal space or airlock space. The airlock space is large enough for a person to maneuver and see from a desired window. The number and placement of the viewports is such that a person within the airlock space has substantially a 360 degree view of the outside of the airlock. Each viewport can have one or multiple windows of multi pane design for increased protection from outside elements such as, but not limited to, ultraviolet radiation, micrometeorite, and space junk debris. The window can have similar characteristics to prevent scratching and punctures from within the airlock.

In the present embodiment, the outside of the airlock has a number of thrusters 20. The thrusters 20 can be used to assist in docking procedures or in attitude control and navigating the module. The propellant tanks for the thrusters can be incorporated as part of the airlock, or in other embodiments may be located external to the airlock and the fuel and oxidizer pumped to the thrusters.

The inside of the airlock is also large enough so that a person can use a camera, small telescopes, or other scientific equipment. There are also attachment points and brackets within the enclosure 12 to allow attachment of astronaut suits or equipment. The airlock has connectors for data, power and gas (air ventilation) exchange with the docked spacecraft or the spacecraft attached at the bulkhead. The airlock also can have equipment associated with navigation, guidance, capture, and data exchange with a spacecraft approaching for docking.

The viewports can allow crew members a visual opportunity to assist spacecraft operations such as docking maneuvers and inspection of some of the outside area of the spacecraft. The docking can be either automated or performed manually.

Within the airlock there is a control panel. The control panel can perform numerous functions including, but not limited to, communicating with the spacecraft, determining the status of the airlock, and control of the docking port. The panel can also provide for other functions associated with the spacecraft.

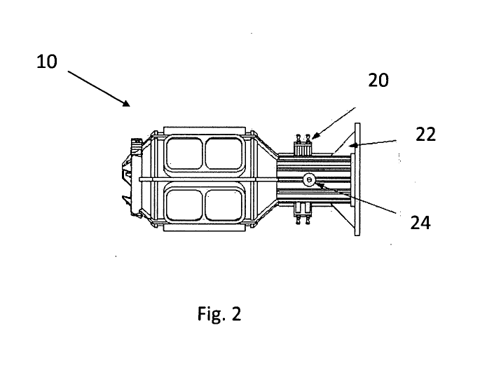

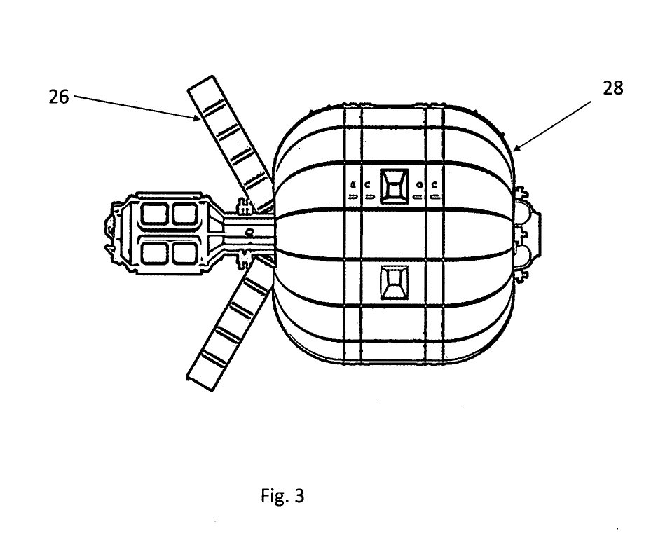

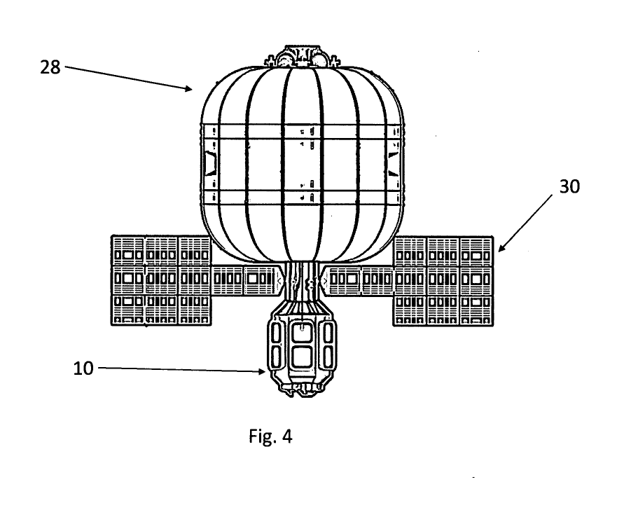

Turning to FIG. 2, in this embodiment, there is at least one radiator attachment point 22 and at least one solar array attachment point 24. FIG. 3 identifies radiators 26 and a human habitable inflatable module 28. FIG. 4 is a top view of the airlock 1o attached to the module 28 and two arrays of solar cells 30. The solar cells can provide power to the airlock 10 and to the module 28.

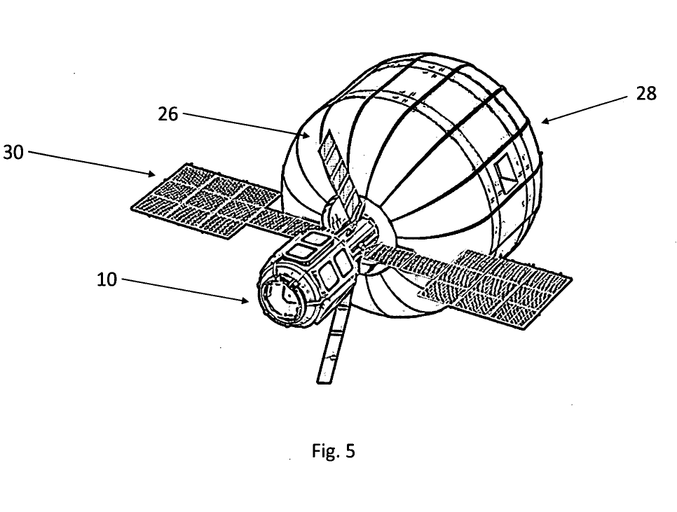

FIG. 5 is an angled view of the front of the airlock 10 attached to a module 28 showing the radiators 26 and the solar cells 30.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. An airlock for use with a spacecraft, the spacecraft having an internal volume, the airlock comprising:
an enclosure defining an airlock space, the enclosure having a substantially cylindrical shape with a first end of the enclosure adapted to attach to a bulkhead of the spacecraft, a second end of the enclosure having a docking port, an external surface of the enclosure, and the enclosure having a plurality of enlarged viewports that provide substantially a 360 degree view from within the airlock;
a plurality of thrusters disposed on the external surface of the enclosure;
at least one solar array attachment point on the external surface;
at least one radiator attachment point disposed on the external surface; and
a control panel within the airlock space, and the control panel providing communications with the spacecraft, status of the airlock, and control for the docking port;
wherein the docking port is adapted to dock with another spacecraft and the airlock providing access to the internal volume of the spacecraft.
